(19) United States
(12) Patent Application Publication
(10) Pub. No.: US 2026/0351901 A1
(43) Pub. Date: Nov. 5, 2026

(54) CONNECTION SYSTEM, CONNECTOR AND METHOD FOR MANUFACTURING ROUTING STRUCTURE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Hiroshi YAMAGUCHI, Mie (JP)

(21) Appl. No.: 19/488,069

(22) PCT Filed: May 15, 2024
(86) PCT No.: PCT/JP2024/017909

§ 371 Date: Nov. 26, 2025

(30) Foreign Application Priority Data
May 31, 2023 (JP) 2023-089786

(51) Int. Cl. H01R 13/64; H01R 13/02; H01R 13/50; H01R 43/26

(52) U.S. Cl. CPC H01R 13/64; H01R 13/025; H01R 13/50; H01R 43/26; H01R 2201/26

(57) ABSTRACT

A connection system includes a male connector, a first female connector and a second female connector. With the first female connector connected to the male connector, a first female terminal is in contact with a first contact region in a male terminal. With the second female connector connected to the male connector, a second female terminal is in contact with a second contact region at a position shifted from the first contact region in the male terminal.

### TECHNICAL FIELD

The present disclosure relates to a connection system, a connector and a method for manufacturing a routing structure.

### BACKGROUND

A connector is configured such that terminals (terminal fittings) provided on end parts of wires are accommodated in cavities provided in a connector housing (for example, Patent Document 1).

### PRIOR ART DOCUMENT

### Patent Document

Patent Document 1: JP 2019-002074 A

### SUMMARY OF THE INVENTION

### Problems to be Solved

For example, in a vehicle such as an automotive vehicle, various devices installed in the vehicle may be connected to devices on a vehicle body side via connectors. In this case, the connector is replaced in exchanging the in-vehicle device (e.g. when a device of a new version is released according to the addition of device functions after the purchase of the vehicle and the device of an old version is replaced by the device of the new version). In the case of replacing the connector, contact resistance between the terminals is required to be kept low without being increased even in a state after the replacement.

Accordingly, the present disclosure aims to provide a technique capable of suppressing an increase in contact resistance between terminals when a connector is replaced.

### Means to Solve the Problem

A connection system of the present disclosure is provided with a male connector including a male terminal and a male housing for accommodating the male terminal, a first female connector including a first female terminal and a first female housing for accommodating the first female terminal, and a second female connector including a second female terminal and a second female housing for accommodating the second female terminal, the first female terminal contacting a first contact region in the male terminal with the first female connector connected to the male connector, and the second female terminal contacting a second contact region at a position shifted from the first contact region in the male terminal with the second female connector connected to the male connector.

A connector of the present disclosure is provided with a female terminal and a female housing for accommodating the female terminal, the female housing having a restricting surface for restricting a connection position of the female housing to a male housing by contacting the male housing, and the connection position being restricted by the restricting surface, whereby a region to be contacted by the female terminal in a male terminal accommodated in the male housing is at a position shifted from a region to be contacted by the female terminal when the connection position is not restricted by the restricting surface.

A method for manufacturing a routing structure of the present disclosure is provided with a removal step of removing a first female connector including a first female terminal and a first female housing for accommodating the first female terminal from a male connector including a male terminal and a male housing for accommodating the male terminal, and a connection step of connecting a second female connector including a second female terminal and a second female housing for accommodating the second female terminal to the male connector having the first female connector removed therefrom, thereby bringing the second female terminal into contact with a second contact region at a position shifted from a first contact region held in contact with the first female terminal in the male terminal.

### Effect of the Invention

According to the present disclosure, an increase in contact resistance between terminals can be suppressed when a connector is replaced.

### BRIEF DESCRIPTION OF THE DRAWINGS

FIG. 1 is a perspective view showing a connection system according to a first embodiment.

FIG. 2 is a side view in section showing the connection system.

FIG. 3 is a perspective view showing a state where a first female connector is connected to a male connector.

FIG. 4 is a side view in section showing the state where the first female connector is connected to the male connector.

FIG. 5 is a perspective view showing a state where a second female connector is connected to the male connector.

FIG. 6 is a side view in section showing the state where the second female connector is connected to the male connector.

FIG. 7 is a perspective view showing a connection system according to a second embodiment.

FIG. 8 is a perspective view showing a state where a first female connector is connected to a male connector.

FIG. 9 is a perspective view showing a state where a second female connector is connected to the male connector.

FIG. 10 is a perspective view showing a connection system according to a modification.

FIG. 11 is a perspective view showing a connection system according to a modification.

### DETAILED DESCRIPTION TO EXECUTE THE INVENTION

### Description of Embodiments of Present Disclosure

First, embodiments of the present disclosure are listed and described.

The connection system of the present disclosure is as follows.

(1) The connection system of the present disclosure is provided with a male connector including a male terminal and a male housing for accommodating the male terminal, a first female connector including a first female terminal and a first female housing for accommodating the first female terminal, and a second female connector including a second female terminal and a second female housing for accommodating the second female terminal, the first female terminal contacting a first contact region in the male terminal with the first female connector connected to the male connector, and the second female terminal contacting a second contact region at a position shifted from the first contact region in the male terminal with the second female connector connected to the male connector.

Even if a plating in the first contact region is stripped when the connector to be connected to the male connector is replaced from the first female connector to the second female connector, a possibility that the second female terminal can contact the male terminal in a region where the plating is not stripped is enhanced. Therefore, an increase in contact resistance between the terminals is suppressed when the connector is replaced.

(2) In the connection system of (1), at least a part of the second contact region may be located closer to a base end of the male terminal than the first contact region. In this case, even if the plating in a region closer to the tip of the male terminal than the first contact region is stripped, for example, when the connector to be connected to the male connector is replaced from the first female connector to the second female connector, a possibility that the second female terminal can contact the male terminal in a region where the plating is not stripped is enhanced. Therefore, contact resistance between the terminals is particularly less likely to increase when the connector is replaced.

(3) In the connection system of (1) or (2), the second contact region may be a region not overlapping the first contact region entirely at all. In this case, even if the plating in the first contact region is stripped, for example, when the connector to be connected to the male connector is replaced from the first female connector to the second female connector, the possibility that the second female terminal can contact the male terminal in the region where the plating is not stripped is sufficiently enhanced. Therefore, contact resistance between the terminals is particularly less likely to increase when the connector is replaced.

(4) In the connection system of any one of (1) to (3), the first female housing may have a restricting surface for restricting a connection position of the first female housing to the male housing to a position shifted from a connection position of the second female housing to the male terminal by contacting the male housing. In this case, the first and second contact regions can be shifted by a simple configuration.

(5) In the connection system of (4), the first female terminal and the second female terminal may have the same shape. In this case, since the first and second female terminals can be formed by common components, the number of types of components used in the entire connection system can be suppressed.

(6) In the connection system of (4) or (5), the first female housing may include a projecting portion having the restricting surface. In this case, the connection position of the first female housing to the male housing can be restricted without complicating the shape of the first female housing.

(7) In the connection system of any one of (4) to (6), the restricting surface may contact an end surface of the male housing on a side where the first female housing is inserted. In this case, the connection position of the first female housing to the male housing can be restricted without complicating the shape of the male housing.

(8) In the connection system of (6) or (7), the male housing may include a groove, and the projecting portion may be accommodated into the groove and the restricting surface may contact an end surface in an extension direction of the groove. Since the connection of the male housing and the first female housing is allowed only when the position of the groove and that of the projecting portion correspond, a connection error and the like hardly occur.

(9) In the connection system of any one of (1) to (3), the first female housing may have a first restricting surface for restricting a connection position of the first female housing to the male housing to a first position by contacting the male housing, and the second female housing may have a second restricting surface for restricting a connection position of the second female housing to the male housing to a second position shifted from the first position by contacting the male housing. In this case, the respective positions of the first and second contact regions can be independently specified.

(10) In the connection system of any one of (1) to (9), in a state where the first female housing is inserted in a recess of the male housing and the first female connector is connected to the male connector, a gap may be provided between a back surface of the recess and an end surface of the first female housing facing the back surface. By providing such a gap, the first contact region can be shifted toward the tip of the male terminal by the size of the gap.

(11) Further, the connector of the present disclosure is provided with a female terminal and a female housing for accommodating the female terminal, the female housing having a restricting surface for restricting a connection position of the female housing to a male housing by contacting the male housing, and the connection position being restricted by the restricting surface, whereby a region to be contacted by the female terminal in a male terminal accommodated in the male housing is at a position shifted from a region to be contacted by the female terminal when the connection position is not restricted by the restricting surface.

Even if a plating in a region held in contact with the female terminal of the connector before replacement is stripped when the connector to be connected to the male connector is replaced from the connector having the connection position restricted by the restricting surface to a connector having a connection position not restricted by the restricting surface, a possibility that a female terminal of the connector after the replacement can contact the male terminal in a region where the plating is not stripped is enhanced. Therefore, an increase in contact resistance between the terminals is suppressed when the connector is replaced.

(12) Further, the method for manufacturing a routing structure of the present disclosure is provided with a removal step of removing a first female connector including a first female terminal and a first female housing for accommodating the first female terminal from a male connector including a male terminal and a male housing for accommodating the male terminal, and a connection step of connecting a second female connector including a second female terminal and a second female housing for accommodating the second female terminal to the male connector having the first female connector removed therefrom, thereby bringing the second female terminal into contact with a second contact region at a position shifted from a first contact region held in contact with the first female terminal in the male terminal.

Even if a plating in the first contact region is stripped when the second female connector is connected to the male connector, a possibility that the second female terminal can contact the male terminal in a region where the plating is not stripped is enhanced. Therefore, an increase in contact resistance between the terminals is suppressed in the routing structure manufactured by replacing the connector.

### Details of Embodiments of Present Disclosure

Specific examples of a connection system, a connector and a method for manufacturing a routing structure of the present disclosure are described below with reference to the drawings. Note that the present disclosure is not limited to these illustrations, but is represented by claims and intended to include all changes in the scope of claims and in the meaning and scope of equivalents.

### First Embodiment

### (1. Configuration of Connection System)

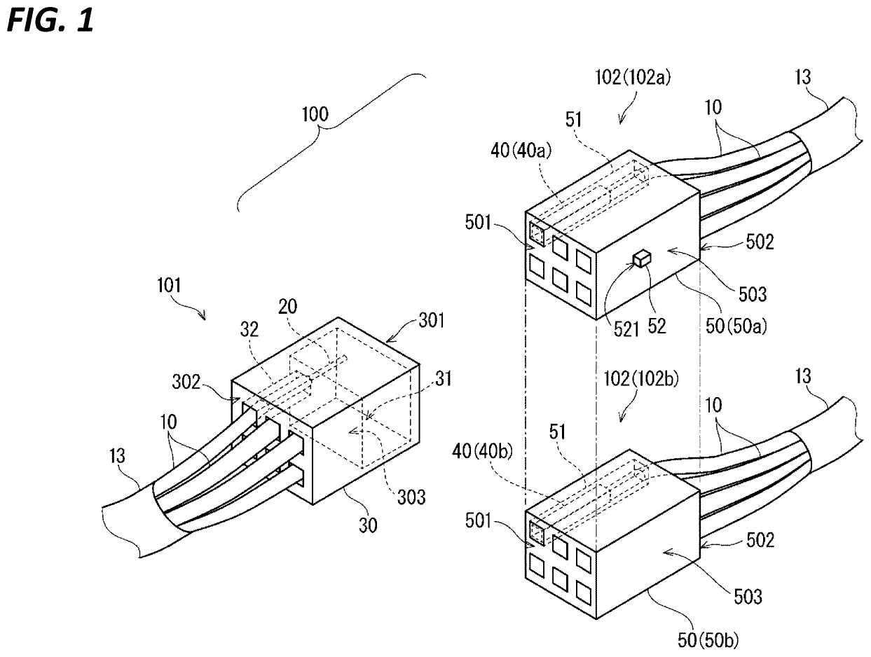

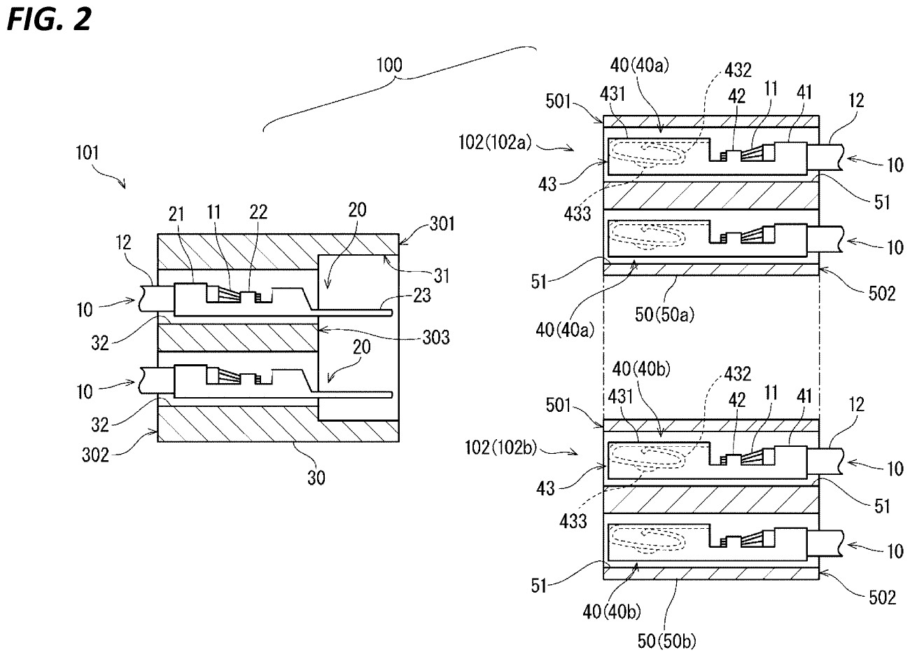

The configuration of a connection system 100 according to a first embodiment is described with reference to FIGS. 1 and 2. FIG. 1 is a perspective view schematically showing the connection system 100. FIG. 2 is a side view in section schematically showing the connection system 100.

The connection system 100 is a system for electrically connecting various devices and provided with a male connector 101, a first female connector 102a and a second female connector 102b. When the first and second female connectors 102a, 102b are not distinguished below, these are merely referred to as “female connectors 102”.

### (i) Basic Configuration

The male connector 101 is provided with terminals (male terminals) 20 provided on end parts of wires 10 and a connector housing (male housing) 30 for accommodating the male terminals 20. The female connector 102 is provided with terminals (female terminals) 40 provided on end parts of wires 10 and a connector housing (female housing) 50 for accommodating the female terminals 40. The wire 10 and the terminal 20, 40 provided on the end part of the wire 10 may be called a terminal-equipped wire. Further, the terminal-equipped wires and the connector housing 30, 50 for accommodating the terminals 20, 40 of the terminal-equipped wires may be called connector-equipped wires, a wiring harness or the like.

### (Wire)

The wire 10 is, for example, an insulated wire and includes a core wire 11 and an insulation coating 12 surrounding the core wire 11. The core wire 11 is an electrically conductive member (conductor) and made of one of various electrically conductive materials (e.g. copper, copper alloy, aluminum, aluminum alloy or the like). The insulation coating 12 is a non-electrically conductive flexible coating and made of one of various synthetic resin materials (e.g. polyvinyl chloride (PVC), polypropylene (PP), polyethylene (PE) or cross-linked polyethylene (XLPE) or the like).

### (Terminals)

Any of the male terminals (male terminal fittings) 20 and the female terminals (female terminal fittings) 40 is an electrically conductive member and includes a base body portion and a plating (plating layer) covering the base body portion. The base body portion is, for example, made of copper, brass, copper alloy or the like. The plating is made of tin (Sn), tin alloy (e.g. tin alloy obtained by adding silver, copper, bismuth or the like to tin), precious metal (e.g. gold, silver) or the like. By providing the plating, an increase in contact resistance between the terminals is suppressed. That is, by providing the plating, an oxide film and the like are hardly formed on the surface of the base body portion, wherefore an increase in film resistance (consequently, contact resistance) is suppressed.

A coating connecting portion 21 and a core wire connecting portion 22 are provided on one end side (base end side) of the male terminal 20. Similarly, a coating connecting portion 41 and a core wire connecting portion 42 are provided on one end side (base end side) of the female terminal 40. The coating connecting portion 21, 41 is mechanically connected to an end part of the insulation coating 12. Connection between the coating connecting portion 21, 41 and the insulation coating 12 is realized by an appropriate method (e.g. crimping or the like). Further, the core wire 11 extends out by a certain length from the end part of the insulation coating 12 (i.e. the insulation coating 12 is stripped from around the core wire 11 by the certain length to expose the core wire 11), and the core wire connecting portion 22, 42 is mechanically and electrically connected to this extending part of the core wire 11. Connection between the core wire connecting portion 22, 42 and the core wire 11 is realized by an appropriate method (e.g. crimping, ultrasonic welding, resistance welding, soldering or the like).

A contact point portion 23 to be electrically connected to a mating terminal is provided on the other end side (tip side) of the male terminal 20. The contact point portion 23 of the male terminal 20 has an elongated shape (e.g. a bar shape, a tab shape, a pin shape or the like). Similarly, a contact point portion 43 to be electrically connected to a mating terminal is provided also on the other end side (tip side) of the female terminal 40. The contact point portion 43 of the female terminal 40 includes a tube part 431 having a tubular shape and a spring piece 432 having a spring structure and formed inside the tube part 431. A protrusion 433 is, for example, provided on the lower surface of the spring piece 432.

### (Male Housing)

The male housing 30 is an enclosure made of an insulating material such as a resin and, for example, formed by molding. The male housing 30 has, for example, a rectangular parallelepiped outer shape, and a recess 31 is provided in one end surface (insertion surface 301). Further, the male housing 30 is provided with one or more (six in the shown example) terminal accommodation chambers (cavities) 32 penetrating from another end surface (back surface) 302 to a back surface 303 of the recess 31. The male terminal 20 is individually accommodated in each terminal accommodation chamber 32. The male terminal 20 is, for example, inserted into the terminal accommodation chamber 32 through the back surface 302 and fixed (e.g. fixed by locking) in the terminal accommodation chamber 32 with the coating connecting portion 21 and the core wire connecting portion 22 accommodated in the terminal accommodation chamber 32 and the contact point portion 23 extending into the inside of the recess 31. The respective wires 10 extending from the back surface 302 may be tied by a tying tool 13 such as an adhesive tape or a zip tie.

### (Female Housing)

The female housing 50 is an enclosure made of an insulating material such as a resin, similarly to the male housing 30, and, for example, formed by molding. The female housing 50 has, for example, a rectangular parallelepiped outer shape, and is provided with one or more (six in the shown example) terminal accommodation chambers (cavities) 51 penetrating from one end surface (inserting surface) 501 to another end surface (back surface) 502. The female terminal 40 is individually accommodated in each terminal accommodation chamber 51. The female terminal 40 is, for example, inserted into the terminal accommodation chamber 51 through the back surface 502 and fixed (e.g. fixed by locking) in the terminal accommodation chamber 51 while being entirely accommodated in the terminal accommodation chamber 51. The respective wires 10 extending from the back surface 502 may be tied by a tying tool 13 such as an adhesive tape or a zip tie.

### (ii) First Female Connector and Second Female Connector

As described above, the connection system 100 is provided with two female connectors 102 (i.e. the first female connector 102a and the second female connector 102b). The first and second female connectors 102a, 102b are different in the presence or absence of a projecting portion 52. That is, the projecting portion 52 is provided on a surface (side surface) 503 intersecting the inserting surface 501 in the female housing 50 (hereinafter, also referred to as a “first female housing 50a”) of the first female connector 102a. On the other hand, the projecting portion 52 is not provided on a side surface 503 of the female housing 50 (hereinafter, also referred to as a “second female housing 50b”) of the second female connector 102b.

The first and second female connectors 102a, 102b are the same except the presence or absence of the projecting portion 52. That is, the female terminals 40 (hereinafter, also referred to as “first female terminals 40a”) of the first female connector 102a and the female terminals 40 (hereinafter, also referred to as “second female terminals 40b”) of the second female connector 102b have the same shape. Further, the first and second female housings 50a, 50b have the same shape except the presence or absence of the projecting portion 52. Further, the positions of the first female terminals 40a with respect to the first female housing 50a are the same as those of the second female terminals 40b with respect to the second female housing 50b.

### (2. Connection of Connectors)

### (Connection of First Female Connector 102a)

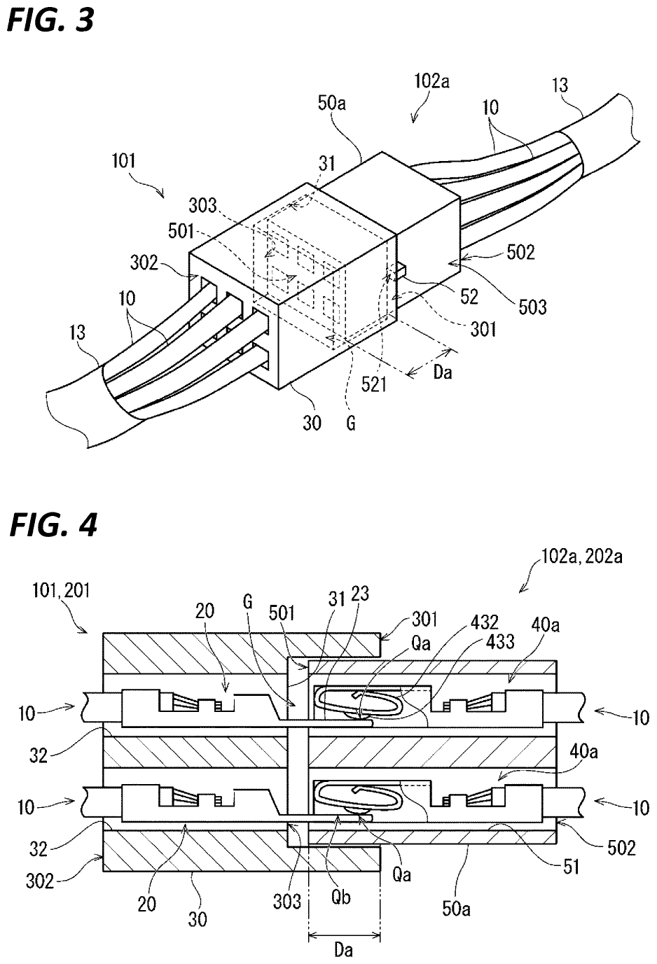

The connection of the male connector 101 and the first female connector 102a is described with reference to FIGS. 3 and 4. FIG. 3 is a perspective view schematically showing a state where the first female connector 102a is connected to the male connector 101. FIG. 4 is a side view in section schematically showing the state where the first female connector 102a is connected to the male connector 101.

In connecting the first female connector 102a to the male connector 101, the insertion surface 301 of the male housing 30 and the inserting surface 501 of the first female housing 50a are arranged to face each other. Then, the first female housing 50a is relatively moved to approach the male housing 30, and the first female housing 50a is inserted (pushed) into the recess 31 from the side of the insertion surface 301 of the male housing 30. When the first female housing 50a is inserted into the recess 31 by a first insertion amount Da, the projecting portion 52 (specifically, a side surface (restricting surface) 521 of the projecting portion 52 on the side of the inserting surface 501) comes into contact with (contacts) the insertion surface 301 of the male housing 30 and the first female housing 50a is not inserted any deeper. In this stage, the connection of the male connector 101 and the first female connector 102a is completed.

With the first female connector 102a connected to the male connector 101, the back surface 303 of the recess 31 of the male housing 30 and the inserting surface 501 of the first female housing 50a facing the back surface 303 are not in contact yet and a gap G is provided between the two surfaces 303 and 501. Further, with the first female connector 102a connected to the male connector 101, the first female terminal 40a is in contact with first contact region Qa of the male terminal 20. Specifically, the spring piece 432 of the first female terminal 40a is resiliently biased downward, whereby an end part on a projecting side of the protrusion 433 provided on the lower surface of the spring piece 432 contacts the first contact region Qa of the contact point portion 23. In this way, the male terminal 20 and the first female terminal 40a are electrically connected.

### (Connection of Second Female Connector 102b)

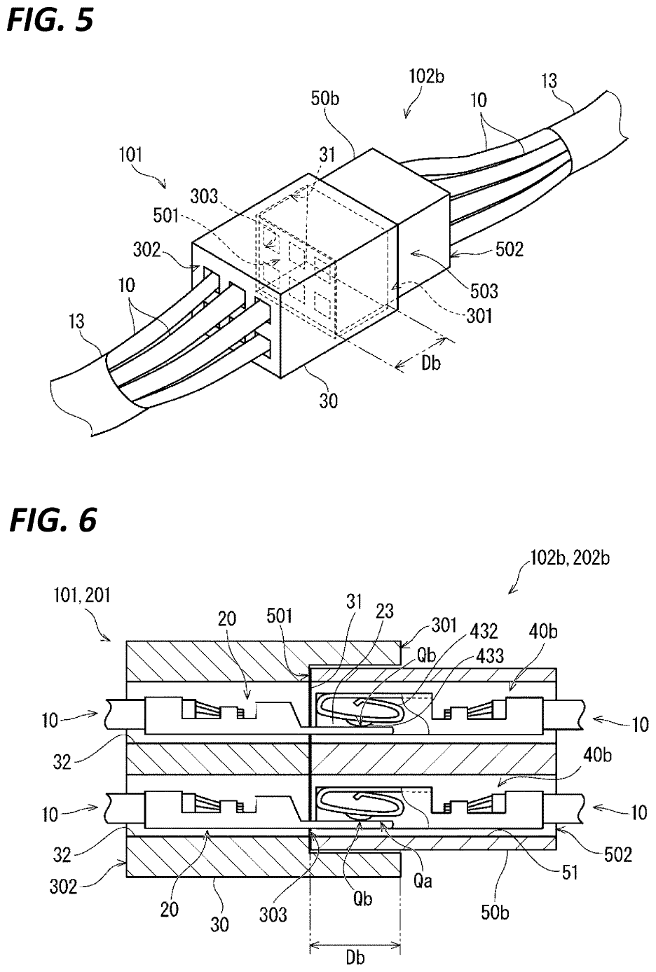

Next, the connection of the male connector 101 and the second female connector 102b is described with reference to FIGS. 5 and 6. FIG. 5 is a perspective view schematically showing a state where the second female connector 102b is connected to the male connector 101. FIG. 6 is a side view in section schematically showing the state where the second female connector 102b is connected to the male connector 101.

In connecting the second female connector 102b to the male connector 101, the insertion surface 301 of the male housing 30 and the inserting surface 501 of the second female housing 50b are arranged to face each other. Then, the second female housing 50b is relatively moved to approach the male housing 30, and the second female housing 50b is inserted (pushed) into the recess 31 from the side of the insertion surface 301 of the male housing 30. Since the second female housing 50b is not provided with the projecting portion 52, the second female housing 50b is inserted by more than the first insertion amount Da (deeper) into the recess 31. When the second female housing 50b is inserted into the recess 31 by a second insertion amount Db (i.e. the second insertion amount Db larger than the first insertion amount Da), the inserting surface 501 comes into contact with (contacts) the back surface 303 of the recess 31 and the second female housing 50b is not inserted any deeper. In this stage, the connection of the male connector 101 and the second female connector 102b is completed.

With the second female connector 102b connected to the male connector 101, the second female terminal 40b is in contact with a second contact region Qb of the male terminal 20. Specifically, the spring piece 432 of the second female terminal 40b is resiliently biased downward, whereby an end part on a projecting side of the protrusion 433 provided on the lower surface of the spring piece 432 contacts the second contact region Qb of the contact point portion 23. In this way, the male terminal 20 and the second female terminal 40b are electrically connected. However, the second contact region Qb is at a position shifted from the first contact region Qa. That is, as described above, the connection position of the first female housing 50a to the male housing 30 is restricted to a position shifted from the connection position of the second female housing 50b to the male housing 30 (specifically, a position having a relatively small (shallow) insertion amount) by the contact of the restricting surface 521 provided on the first female housing 50a with the insertion surface 301. Thus, the second contact region Qb is at the position shifted from the first contact region Qa. Specifically, the second contact region Qb is at least partially located closer to the base end side (side of end part of the contact point portion 23 connected to the core wire connecting portion 22) than the first contact region Qa.

### (3. Replacement of Connectors)

Next, a usage mode of the connection system 100 is described. The connection system 100 is, for example, used, in a vehicle such as an automotive vehicle, to connect a device installed in the vehicle (in-vehicle device) and a device on a vehicle body side. In this case, for example, the male connector 101 is used as the connector of the device on the vehicle body side (i.e. the connector provided on the end parts of the wires 10 extending from the device on the vehicle body side), and the female connector 102 is used as the connector of the in-vehicle device (i.e. the connector provided on the end parts of the wires 10 extending from the in-vehicle device).

The in-vehicle device may be replaced. For example, if a device of a new version is released according to the addition of device functions after the purchase of the vehicle, the device (device of an old version) assembled already at the time of shipment of the vehicle is replaced by the device of the new version. Further, an old device may be replaced by a new device, for example, at the time of maintenance. Here, the first female connector 102a is used as the connector of the device before the replacement, and the second female connector 102b is used as the connector of the device after the replacement. That is, the first female connector 102a is used as the connector of the device assumed to be replaced by a new device in the future, and the second female connector 102b is used as the connector of the new device replacing the existing device.

For example, the device before the replacement is assembled with the vehicle, such as at the time of shipment of the vehicle. In this state, the device before the replacement and the device on the vehicle body side are electrically connected by connecting the first female connector 102a to the male connector 101. That is, a routing structure including the first female connector 102a and the male connector 101 connected to the first female connector 102a is formed (FIGS. 3 and 4). Thereafter, such as when a device of a new version is released, the in-vehicle device is replaced by the new device. At this time, the connector to be connected to the male connector 101 is replaced from the first female connector 102a to the second female connector 102b. Specifically, the first female connector 102a is first removed from the male connector 101 (removal step). Then, the second female connector 102b is connected to the male connector 101 having the first female connector 102a removed therefrom (connection step). In this way, the device after the replacement and the device on the vehicle body side are electrically connected. That is, a routing structure (routing structure after the device replacement) including the second female connector 102b and the male connector 101 connected to the second female connector 102b is formed (FIGS. 5 and 6).

As described above, with the first female connector 102a connected to the male connector 101, the first female terminals 40a are in contact with the first contact regions Qa of the male terminals 20 (FIG. 4). If a relatively long time (e.g. about several years) passes with the first female connector 102a kept connected to the male connector 101, the male terminals 20 and the first female terminals 40a may be firmly fixed. If the fixed terminals 20, 40a are forcibly pulled apart in removing the first female connector 102a from the male connector 101, there is a possibility that the plating in the first contact regions Qa is stripped. Further, when the first female connector 102a is removed from the male connector 101, the spring pieces 432 of the first female terminals 40a move to the tip sides of the male terminals 20 while being resiliently biased by the male terminals 20. Thus, the first contact regions Qa and regions closer to the tips than the first contact regions Qa are subject to friction (adhesive friction forces, digging-up friction forces) and the plating in these regions is possibly stripped (disappears due to wear). Further, while the first female connector 102a is connected to the male connector 101, the plating in the first contact regions Qa is possibly stripped (disappears due to wear) by the first female terminals 40a repeatedly finely sliding with respect to the male terminals 20 due to vibration during the travel of the vehicle, impacts from outside, thermal expansion and contraction associated with a temperature change and the like.

With the first female connector 102a removed from the male connector 101, if the plating in the first contact regions Qa is stripped, contact resistance between the terminals may increase if terminals of a new connector contact the regions of the male terminals 20 where the plating is stripped when the new connector is connected to the male connector 101 (i.e. in the updated routing structure). That is, even if the plating is not stripped in the terminals of the new connector, oxide films and the like may be, for example, formed at stripped positions and the contact resistance between the terminals may increase if the plating is stripped in the male terminals 20.

If the new connector to be connected to the male connector 101 having the first female connector 102a removed therefrom is the second female connector 102b, such a situation hardly occurs. That is, if the second female connector 102b is connected to the male connector 101, the second female terminals 40b contact the second contact regions Qb at the positions shifted from the first contact regions Qa in the male terminals 20 (FIG. 6). Thus, even if the plating in the first contact regions Qa is stripped, there is a high possibility that the second female terminals 40B can contact the male terminals 20 in regions where the plating is not stripped. Particularly, if the second contact regions Qb are at least partially located closer to the base ends of the male terminals 20 than the first contact regions Qa, there is a high possibility that the second female terminals 40b can contact the male terminals 20 in the regions where the plating is not stripped even if the plating in the regions closer to the tips than the first contact regions Qa is stripped. By the contact of the second female terminals 40b with the male terminals 20 in the regions where the plating is not stripped, an increase in contact resistance between the terminals 20 and 40b is avoided.

### (4. Effects, Etc.)

The connection system 100 configured as described above is provided with the male connector 101, the first female connector 102a and the second female connector 102b, the first female terminals 40a are in contact with the first contact regions Q1 in the male terminals 20 with the first female connector 102a connected to the male connector 101, and the second female terminals 40b are in contact with the second contact regions Qb at the positions shifted from the first contact regions Qa in the male terminals 20 with the second female connector 102b connected to the male connector 101. Accordingly, even if the plating in the first contact region Qa is stripped, for example, when the connector to be connected to the male connector 101 is replaced from the first female connector 102a to the second female connector 102b, a possibility that the second female terminal 40b can contact the male terminal 20 in the region where the plating is not stripped is enhanced. Therefore, an increase in contact resistance between the terminals 20 and 40b is suppressed when the connector is replaced.

Further, in the connection system 100, the second contact regions Qb are at least partially located closer to the base ends of the male terminals 20 than the first contact regions Qa. In this case, even if the plating is stripped in the regions closer to the tips of the male terminals 20 than the first contact regions Qa when the first female connector 102a is replaced by the second female connector 102b, a possibility that the second female terminals 40b can contact the male terminals 20 in the regions where the plating is not stripped is enhanced. Therefore, the contact resistance between the terminals 20 and 40b is particularly less likely to increase when the connector is replaced.

Further, in the connection system 100, the second contact region Qb may be a region not overlapping the first contact region Qa entirely at all or may be a region partially not overlapping the first contact region Qa (i.e. a region overlapping the first contact region Qa in a part and not overlapping the first contact region Qa in the remaining part). Of course, if the second contact region Qb is the region not overlapping the first contact region Qa entirely at all, the possibility that the second female terminal 40b can contact the male terminal 20 in the region where the plating is not stripped is sufficiently enhanced even if the plating in the first contact region Qa is stripped, for example, when the connector to be connected to the male terminal 101 is replaced from the first female connector 102 to the second female connector 102b. Therefore, the contact resistance between the terminals 20 and 40b is particularly less likely to increase when the connector is replaced.

Further, the connection system 100 is provided with the restricting surface 521 for restricting the connection position of the first female housing 50a to the male housing 30 to the position shifted from the connection position of the second female housing 50b to the male housing 30 by contacting the male housing 30. In this case, the first and second contact regions Qa, Qb can be shifted by a simple configuration. Further, a shift amount of the first and second contact regions Qa, Qb can be easily adjusted by the position of the restricting surface 521.

Further, in the connection system 100, the first female terminals 40a and the second female terminals 40b have the same shape. In this case, since the first and second female terminals 40a, 40b can be formed by common components, the number of types of components used in the entire connection system 100 can be suppressed. In this way, a manufacturing process of the connection system 100 becomes more efficient and the manufacturing cost of the connection system 100 is reduced.

Further, in the connection system 100, the first female housing 50a is provided with the projecting portion 52 having the restricting surface 521. In this case, the connection position of the first female housing 50a to the male housing 30 can be restricted without complicating the shape of the first female housing 50a. Further, in this case, the first and second female housings 50a, 50b can have the same shape except the presence or absence of the projecting portion 52. By making most parts of the shapes common, most of the design of one female housing 50a can be used in the design of the other female housing 50b. In this way, the manufacturing process of the connection system 100 becomes more efficient and the manufacturing cost of the connection system 100 is reduced.

Further, in the connection system 100, the restricting surface 521 contacts the end surface (inserting surface) 501 on the side of the male housing 30 where the first female housing 50a is inserted. In this case, the connection position of the first female housing 50a to the male housing 30 can be restricted without complicating the shape of the male housing 30.

Further, in the connection system 100, the gap G is provided between the back surface 303 of the recess 31 and the end surface (inserting surface) 501 of the first female housing 50a facing the back surface 303 with the first female housing 50a inserted in the recess 31 of the male housing 30 and the first female connector 102a connected to the male connector 101. By providing such a gap, the first contact regions Qa can be shifted toward the tip sides of the male terminals 20 by the size of the gap G.

Further, focusing on the first female connector 102a, the first female housing 50a of the first female connector 102a has the restricting surface 521 for restricting the connection position of the first female housing 50a to the male housing 30 by contacting the male housing 30. By restricting the connection position by the restricting surface 521, the regions (first regions) Qa to be contacted by the first female terminals 40a in the male terminals 20 accommodated in the male housing 30 are at the positions shifted from the regions (second regions) Qb to be contacted by the first female terminals 40a when the connection position is not restricted by the restricting surface 521. Therefore, an increase in contact resistance between the terminals 20 and 40a is suppressed, for example, when the connector to be connected to the male connector 101 is replaced from the first female connector 102a having the connection position restricted by the restricting surface 521 to the connector (e.g. the second female connector 102b) having the connection position not restricted by the restricting surface 521.

Further, a method for manufacturing the routing structure using the connection system 100 includes the removal step of removing the first female connector 102a from the male connector 101 and the connection step of connecting the second female connector 102b to the male connector 101 having the first female connector 102a removed therefrom in bringing the second female terminals 40b into contact with the second contact regions Qb at the positions shifted from the first contact regions Qa, with which the first female terminals 40a were in contact. Therefore, in the routing structure manufactured by replacing the connector (e.g. the updated routing structure), an increase in contact resistance between the terminals 20 and 40a is suppressed.

### Second Embodiment

### (1. Configuration of Connection System)

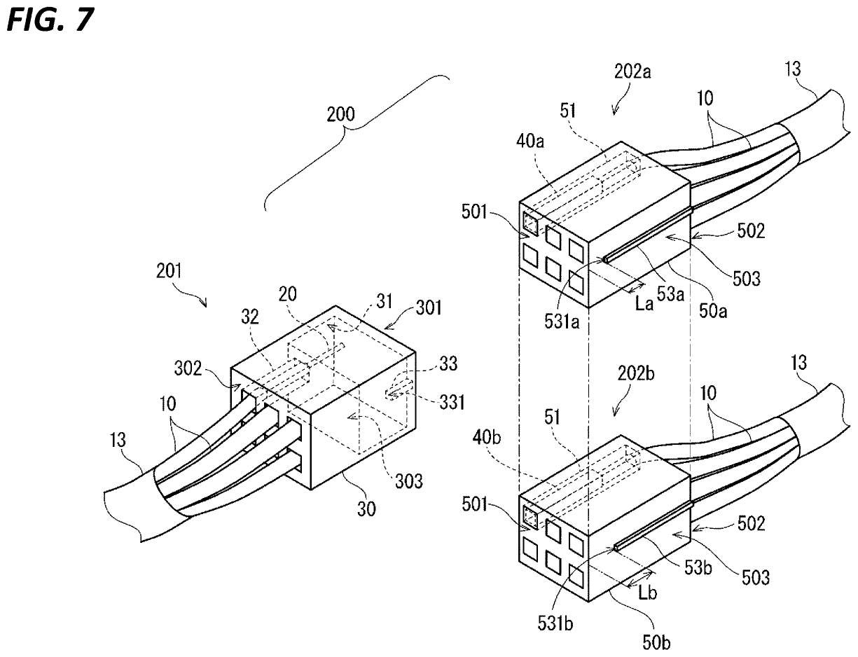

The configuration of a connection system 200 according to a second embodiment is described with reference to FIG. 7. FIG. 7 is a perspective view schematically showing the connection system 200. The elements described in the first embodiment are denoted by the same reference signs and not described below.

The connection system 200 is a system for electrically connecting various devices and provided with a male connector 201, a first female connector 202a and a second female connector 202b.

The male connector 201 is provided with male terminals 20 provided on end parts of wires 10 and a male housing 30 for accommodating the male terminals 20. A groove 33 extending from an insertion surface 301 toward the back of a recess 31 is provided in the inner wall surface of the recess 31 of the male housing 30.

The first female connector 202a is provided with first female terminals 40a provided on end parts of wires 10 and a first female housing 50a for accommodating the first female terminals 40a. A rib-like projecting portion (first projecting portion) 53a extending from a back surface 502 toward an inserting surface 501 is provided at a position corresponding to the groove 33 on a side surface 503 of the first female housing 50a. On the other hand, the second female connector 202b is provided with second female terminals 40b provided on end parts of wires 10 and a second female housing 50b for accommodating the second female terminals 40b. A rib-like projecting portion (second projecting portion) 53b extending from a back surface 502 toward an inserting surface 501 is provided at a position corresponding to the groove 33 on a side surface 503 of the second female housing 50b.

The first and second female connectors 202a, 202b are different in lengths of the projecting portions 53a, 53b. For example, the second projecting portion 53b is shorter than the first projecting portion 53a in an extension direction. That is, a separation distance Lb from the inserting surface 501 of the second female housing 50b to a tip surface (end side on the side of the inserting surface 501) 531b in the extension direction of the second projecting portion 53b is larger than a separation distance La from the inserting surface 501 of the first female housing 50a to a tip surface 531a in the extension direction of the first projecting portion 53a.

The first and second female connectors 202a, 202b are the same except the lengths of the projecting portions 53a, 53b (i.e. the positions of the tip surfaces 531a, 531b). That is, the first and second female terminals 40a, 40b have the same shape. Further, the first and second female connectors 202a, 202b have the same shape except the projecting portions 53a, 53b. Furthermore, the positions of the first female terminals 40a with respect to the first female housing 50a are the same as those of the second female terminals 40b with respect to the second female housing 50b.

### (2. Connection of Connectors)

### (Connection of First Female Connector 202a)

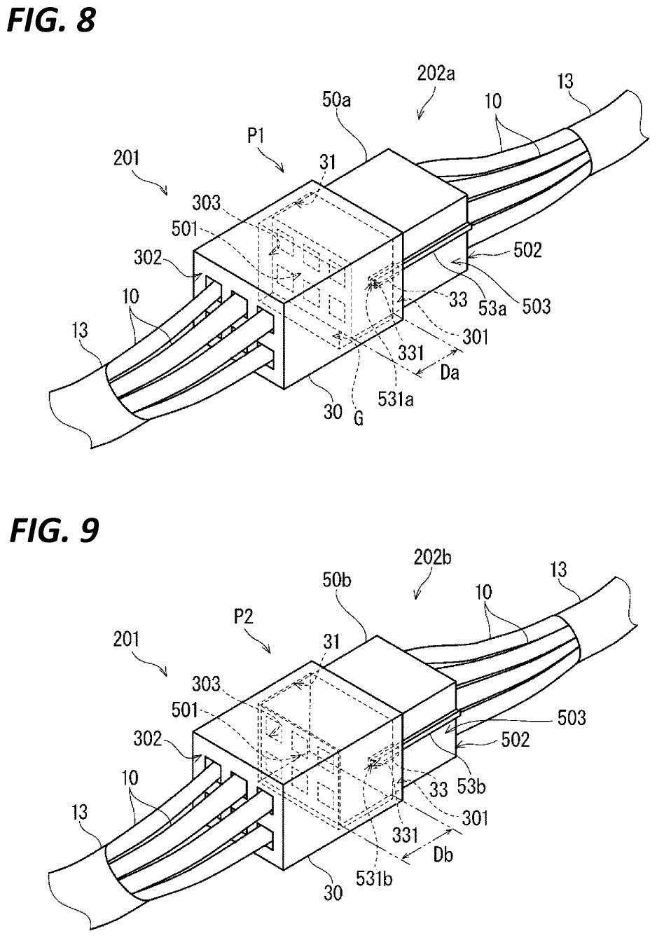

The connection of the male connector 201 and the first female connector 202a is described with reference to FIGS. 8 and 4. FIG. 8 is a perspective view schematically showing a state where the first female connector 202a is connected to the male connector 201. FIG. 4 is a side view in section schematically showing the state where the first female connector 202a is connected to the male connector 201.

In connecting the first female connector 202a to the male connector 201, the insertion surface 301 of the male housing 30 and the inserting surface 501 of the first female housing 50a are arranged to face each other. Then, the first female housing 50a is relatively moved to approach the male housing 30, and the first female housing 50a is inserted into the recess 31 from the side of the insertion surface 301 of the male housing 30. At this time, one end side in the extension direction of the first projecting portion 53a provided on the side surface 503 of the first female housing 50a moves in the extension direction while being accommodated into the groove 33 provided in the inner wall surface of the recess 31. When the first female housing 50a is inserted into the recess 31 by a first insertion amount Da, the tip surface (first restricting surface) 531a in the extension direction of the first projecting portion 53a comes into contact with (contacts) an end surface (surface on a back side of the groove 33) 331 in the extension direction of the groove 33 and the first female housing 50a is not inserted any deeper. In this stage, the connection of the male connector 201 and the first female connector 202a is completed.

With the first female connector 202a connected to the male connector 201, the back surface 303 of the recess 31 of the male housing 30 and the inserting surface 501 of the first female housing 50a facing the back surface 303 are not in contact yet and a gap G is provided between the two surfaces 303 and 501. Further, with the first female connector 202a connected to the male connector 201, the first female terminals 40a are in contact with first contact regions Qa of the male terminals 20. In this way, the male terminals 20 and the first female terminals 40 are electrically connected.

### (Connection of Second Female Connector 202b)

The connection of the male connector 201 and the second female connector 202b is described with reference to FIGS. 9 and 6. FIG. 9 is a perspective view schematically showing a state where the second female connector 202b is connected to the male connector 201. FIG. 6 is a side view in section schematically showing the state where the second female connector 202b is connected to the male connector 201.

In connecting the second female connector 202b to the male connector 201, the insertion surface 301 of the male housing 30 and the inserting surface 501 of the second female housing 50b are arranged to face each other. Then, the second female housing 50b is relatively moved to approach the male housing 30, and the second female housing 50b is inserted (pushed) into the recess 31 from the side of the insertion surface 301 of the male housing 30. At this time, one end side in the extension direction of the second projecting portion 53b provided on the side surface 503 of the second female housing 50b moves in the extension direction while being accommodated into the groove 33 provided in the inner wall surface of the recess 31. When the second female housing 50b is inserted into the recess 31 by a second insertion amount Db, the tip surface (second restricting surface) 531b in the extension direction of the second projecting portion 53b comes into contact with (contacts) the end surface (surface on the back side of the groove 33) 331 in the extension direction of the groove 33 and the second female housing 50b is not inserted any deeper. In this stage, the connection of the male connector 201 and the second female connector 202b is completed. Note that, in this state, the back surface 303 of the recess 31 of the male housing 30 and the inserting surface 501 of the second female housing 50b facing the back surface 303 may or may not be in contact.

With the second female connector 202b connected to the male connector 201, the second female terminals 40b are in contact with second contact regions Qb of the male terminals 20. In this way, the male terminals 20 and the second female terminals 40 are electrically connected. However, the second contact regions Q are at positions shifted from the first contact regions Qa. That is, the connection position of the first female housing 50a to the male housing 30 is restricted to a first position (FIG. 8) by the contact of the first restricting surface 531a provided on the first female housing 50a with the end surface 331 of the groove 33 provided in the male housing 30 as described above. Further, the connection position of the second female housing 50b to the male housing 30 is restricted to a second position (FIG. 9) by the contact of the second restricting surface 531b provided on the second female housing 50b with the end surface 331 of the groove 33 provided in the male housing 30 as described above. Since the separation distance La from the inserting surface 501 to the first restricting surface 531a is smaller than the separation distance Lb from the inserting surface 501 to the second restricting surface 531b, the first position P1 is at a position shifted from the second position P2 (specifically at a position having a relatively small (shallow) insertion amount). Thus, the second contact regions Qb are at the positions shifted from the first contact regions Qb. Specifically, the second contact regions Qb are at least partially located closer to base ends of the male terminals 20 than the first contact regions Qa.

### (3. Effects, Etc.)

Also in the connection system 200 configured as described above, an increase in contact resistance between the terminals 20 and 40b is suppressed, for example, when the connector to be connected to the male connector 201 is replaced from the first female connector 202a to the second female connector 202b, similarly to the connection system 100 according to the first embodiment.

Further, in the connection system 200, the male housing 30 is provided with the groove 33, and the first projecting portion 53a is accommodated into the groove 33 and the first restricting surface 531a contacts the end surface 331 in the extension direction of the groove 33. Since the connection of the male housing 30 and the first female housing 50a is allowed only when the position of the groove 33 and that of the first projecting portion 53a correspond, a connection error and the like hardly occur.

Further, in the connection system 200, the first female housing 50a has the first restricting surface 531a for restricting the connection position of the first female housing 50a to the male housing 30 to the first position P1 by contacting the male housing 30, and the second female housing 50b has the second restricting surface 531b for restricting the connection position of the second female housing 50b to the male housing 30 to the second position P2 by contacting the male housing 30. In this case, the respective positions of the first and second contact regions Qa, Qb can be independently specified.

### Modifications

In the connection systems 100, 200 according to the above respective first and second embodiments, the first and second contact regions Qa, Qb at the positions shifted from each other are not limited to those illustrated above.

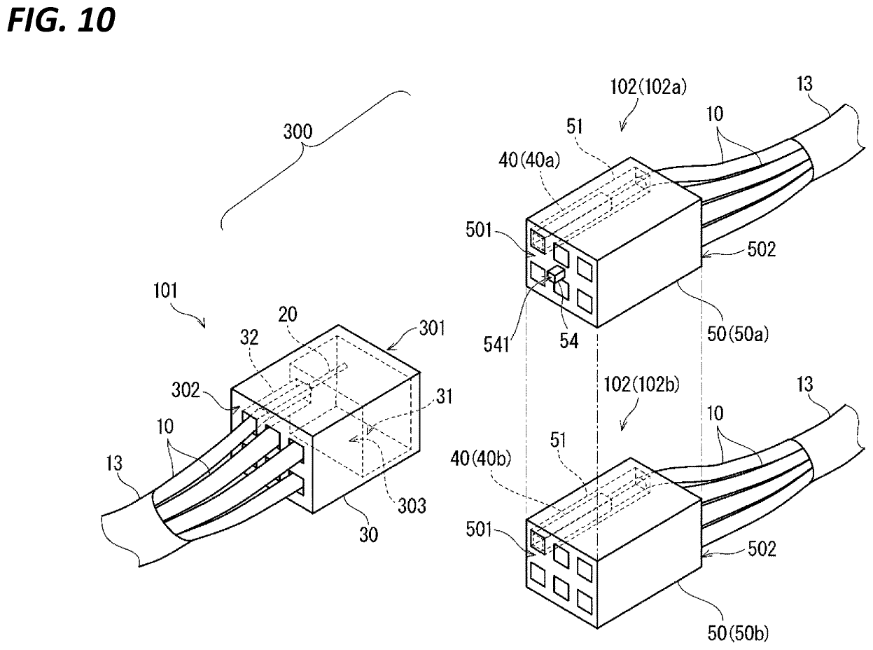

For example, the projecting portion 52 is provided on the side surface 503 of the first female housing 50a in the connection system 100 according to the first embodiment, but a projecting portion 54 may be provided on an inserting surface 501 of a first female housing 50a as in a connection system 300 illustrated in FIG. 10. In this case, when the first female housing 50a is inserted into a recess 31 by a first insertion amount Da, the projecting portion 54 (specifically, an end surface (restricting surface) 541 on a projecting side in the projecting portion 54) comes into contact with a back surface 303 of the recess 31 of a male housing 30 and the first female housing 50a is not inserted any deeper. In this stage, the connection of a male connector 101 and the first female connector 102a is completed. That is, in this case, the restricting surface 541 contacts the back surface 303 of the recess 31, thereby restricting the connection position of the first female housing 50a to the male housing 30.

Further, in the connection system 200 according to the second embodiment, the male housing 30 may be provided with two grooves. The first projecting portion 53a of the first female housing 50a may be provided at a position corresponding to one groove, and the second projecting portion 53b of the second female housing 50b may be provided at a position corresponding to the other groove. In this case, at least either lengths of the respective projecting portions 53a, 53b (i.e. the positions of the respective restricting surfaces 531a, 531b) or lengths of the two grooves (i.e. the positions of the end surfaces of the respective grooves) are made different from each other, whereby the connection position of the first female housing 50a to the male housing 30 and that of the second female housing 50b to the male housing 30 are shifted from each other. Consequently, the first and second contact regions Qa, Qb are at the positions shifted from each other.

Further, in the connection system 200 according to the second embodiment, each female housing 50a, 50b is provided with a convex structure (rib-like projecting portion 53a, 53b) and the male housing 30 is provided with a concave structure (groove 33), but each female housing 50a, 50b may be provided with a concave structure and the male housing 30 may be provided with a convex structure. That is, the convex structure (e.g. a rib-like projecting portion) provided on the inner all surface of the recess 31 of the male housing 30 may be accommodated into the concave structure (e.g. a groove) provided in the side surface 503 of each female housing 50a, 50b, and the connection position may be restricted by the mutual contact of these end surfaces.

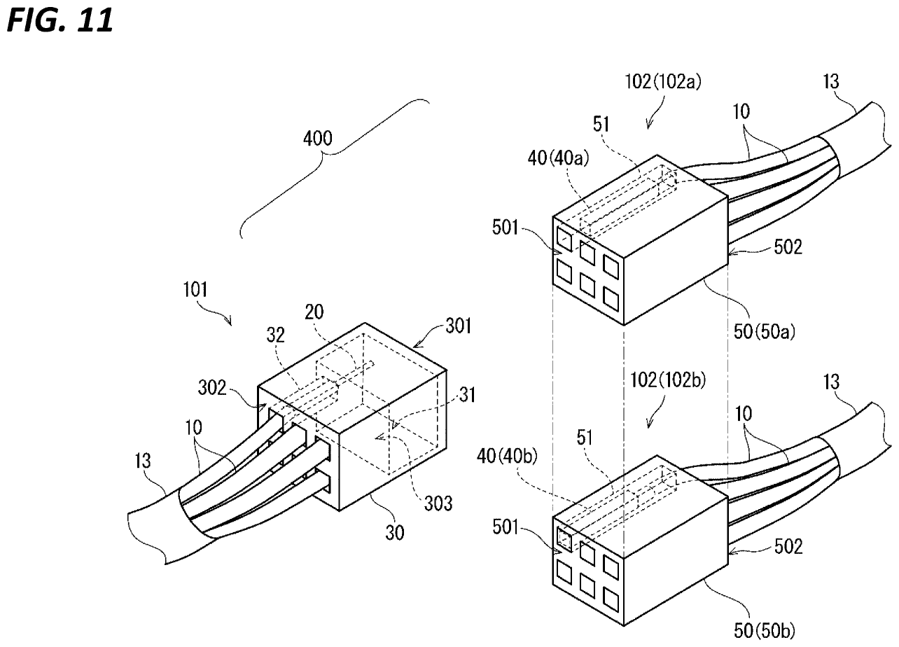

The first and second contact regions Qa, Qb may be set at positions shifted from each other by making the positions (accommodated positions) of the first female terminals 40a with respect to the first female housing 50a and those of the second female terminals 40b with respect to the second female housing 50b different from each other as in a connection system 400 illustrated in FIG. 11. Specifically, for example, the tip positions of the second female terminals 40b with respect to the second female housing 50b may be set to be closer to the inserting surface 501 than those of the first female terminals 40a with respect to the first female housing 50a. In this case, the second contact regions Qb are at positions shifted more toward the base ends of the male terminals 20 than the first contact regions Qa.

Further, the first and second contact regions Qa, Qb may be set at positions shifted from each other, for example, by making the shapes of the first and second female terminals 40a, 40b different from each other. Specifically, a length in the extension direction of the contact point portion 43 of the first female terminal 40a may be set to be shorter than that of the contact point portion 43 of the second female terminal 40b. Alternatively, the formation position of the protrusion 433 on the spring piece 432 in the first female terminal 40a may be shifted more toward the base end of the contact point portion 43 than that of the protrusion 433 on the spring piece 432 in the second female terminal 40b. In either mode, the second contact region Qb is at the position shifted more toward the base end of the male terminal 20 than the first contact region Qa.

In the connection systems 100, 200 according to the respective first and second embodiments, the second contact regions Qb may be at positions shifted in any direction with respect to the first contact regions Qa. For example, the second contact regions Qb may be at least partially closer to the tips of the male terminals 20 than the first contact regions Qa.

In the connection systems 100, 200 according to the respective first and second embodiments, the connector to be first connected to the male connector 101 may be the first female connector 102a, 202a or the second female connector 102b, 202b. That is, the connector to be first connected to the male connector 101 may be replaced from the first female connector 102a, 202a to the second female connector 102b, 202b or may be replaced from the second female connector 102b, 202b to the first female connector 102a, 202a. In either case, an increase in contact resistance between the terminals is suppressed when the connector is replaced.

The connection systems 100, 200 according to the respective first and second embodiments may be used to connect devices to be installed in a vehicle or may be used to connect various other devices.

Note that the respective configurations described in the above first and second embodiments and the respective modifications can be appropriately combined without technically contradicting each other.

### LIST OF REFERENCE NUMERALS

10 wire
11 core wire
12 insulation coating
13 tying tool
20 male terminal
21 coating connecting portion
22 core wire connecting portion
23 contact point portion
Qa first contact region
Qb second contact region
30 male housing
31 recess
32 terminal accommodation chamber
33 groove
301 insertion surface
302 back surface
303 back surface of recess
331 end surface of groove
40a first female terminal
40b second female terminal
41 coating connecting portion
42 core wire connecting portion
43 contact point portion
431 tube part
432 spring piece
433 protrusion
50a first female housing
50b second female housing
51 terminal accommodation chamber
52, 54 projecting portion
53a first projecting portion
53b second projecting portion
501 inserting surface
502 back surface
503 side surface
521, 541, 531a, 531b restricting surface
101, 201 male connector
102a, 202a first female connector
102b, 202b second female connector
100, 200, 300, 400 connection system
Da first insertion amount
Db second insertion amount
G gap
P1 first position
P2 second position

1. A connection system, comprising:
a male connector including a male terminal and a male housing for accommodating the male terminal;
a first female connector including a first female terminal and a first female housing for accommodating the first female terminal; and
a second female connector including a second female terminal and a second female housing for accommodating the second female terminal,
the first female terminal contacting a first contact region in the male terminal with the first female connector connected to the male connector, and
the second female terminal contacting a second contact region at a position shifted from the first contact region in the male terminal with the second female connector connected to the male connector.

2. The connection system of claim 1, wherein at least a part of the second contact region is located closer to a base end of the male terminal than the first contact region.

3. The connection system of claim 1, wherein the second contact region is a region not overlapping the first contact region entirely at all.

4. The connection system of claim 1, wherein the first female housing has a restricting surface for restricting a connection position of the first female housing to the male housing to a position shifted from a connection position of the second female housing to the male terminal by contacting the male housing.

5. The connection system of claim 4, wherein the first female terminal and the second female terminal have the same shape.

6. The connection system of claim 4, wherein the first female housing includes a projecting portion having the restricting surface.

7. The connection system of claim 6, wherein the restricting surface contacts an end surface of the male housing on a side where the first female housing is inserted.

8. The connection system of claim 6, wherein:
the male housing includes a groove, and
the projecting portion is accommodated into the groove and the restricting surface contacts an end surface in an extension direction of the groove.

9. The connection system of claim 1, wherein:
the first female housing has a first restricting surface for restricting a connection position of the first female housing to the male housing to a first position by contacting the male housing, and
the second female housing has a second restricting surface for restricting a connection position of the second female housing to the male housing to a second position shifted from the first position by contacting the male housing.

10. The connection system of claim 1, wherein, in a state where the first female housing is inserted in a recess of the male housing and the first female connector is connected to the male connector, a gap is provided between a back surface of the recess and an end surface of the first female housing facing the back surface.

11. A connector, comprising:
a female terminal; and
a female housing for accommodating the female terminal,
the female housing having a restricting surface for restricting a connection position of the female housing to a male housing by contacting the male housing, and
the connection position being restricted by the restricting surface, whereby a region to be contacted by the female terminal in a male terminal accommodated in the male housing is at a position shifted from a region to be contacted by the female terminal when the connection position is not restricted by the restricting surface.

12. A method for manufacturing a routing structure, comprising:
a removal step of removing a first female connector including a first female terminal and a first female housing for accommodating the first female terminal from a male connector including a male terminal and a male housing for accommodating the male terminal; and
a connection step of connecting a second female connector including a second female terminal and a second female housing for accommodating the second female terminal to the male connector having the first female connector removed therefrom, thereby bringing the second female terminal into contact with a second contact region at a position shifted from a first contact region held in contact with the first female terminal in the male terminal.
